(19) United States
(12) Patent Application Publication
(10) Pub. No.: US 2010/0323593 A1
(43) Pub. Date: Dec. 23, 2010

(54) DUST-PROTECTED HAND-HELD POWER TOOL

(76) Inventors: Volker Hoeschele, Frickenhausen (DE); Heinrich Sikora, Nuertingen (DE)

Correspondence Address: DREISS, FUHLENDORF, STEIMLE & BECKER, POSTFACH 10 37 62, D-70032 STUTTGART, DE

(21) Appl. No.: 12/735,617

(22) PCT Filed: Jan. 29, 2009
(86) PCT No.: PCT/EP2009/000569

§ 371 Date: Aug. 3, 2010

(30) Foreign Application Priority Data
Feb. 15, 2008 (DE) 10 2008 009 277.0

(51) Int. Cl. B25F 5/00; B24B 55/00

(52) U.S. Cl. 451/359; 451/454

(57) ABSTRACT

A battery-operated hand-held power tool (2), especially an angle grinder, comprises a housing base (4) accommodating the electromotive drive components and air inlet openings (10) supplying the electromotive drive components with a cooling air flow. In order to protect the electromotive components from dirt, the hand-held power tool is designed in such a manner that a filter element (20) is provided in the area of the air inlet openings (10) and keeps dust, especially magnetizable dust, away from the electromotive drive components. The filter element (20) is retained by a filter retaining part (12, 30) which can be attached to the exterior of the housing base (4). The filter retaining part (14, 30) can be elastically deformed to such an extent that it is slightly deformed, especially expanded, when attached to the housing base, and engages behind or snaps into an element on the housing base.

The invention relates to an open-circuit-ventilated hand-held power tool, in particular, powered by rechargeable batteries, comprising a housing base accommodating the electromotive drive components, and having air inlet openings supplying the electromotive drive components with a cooling air flow. In particular, the invention relates to hand-held power tools, in which the electromotive drive components comprise permanent magnets.

Hand-held power tools usually require air cooling, which is why air inlet openings are provided in the region of the electromotive drive, through which a cooling air flow is formed over the electromotive drive components. Especially in the case of hand-held power tools for metalworking, in particular, cutting and grinding, such as is performed using angle grinders, the problem arises that, with the cooling air flow, magnetizable dust penetrates into the interior of the hand-held power tools and is deposited on the electromotive components, in particular, on the permanent magnets of the electric motor and is near impossible to remove because of its magnetic adhesion. This can result in considerable damage to the electromotive drive components.

The object of this invention is to solve this problem in a simple and economically viable manner.

This task is inventively solved in a hand-held power tool of this type in that a filter element is provided in the area of the air inlet openings by means of which dust, especially magnetizable dust, can be kept away from the electromotive drive components, the filter element is retained by a filter retaining part that can be attached to the exterior of the housing base, the filter retaining part can be elastically deformed to such an extent that it is slightly deformed, especially expanded, when attached to the housing base, and engages behind or snaps into an element on the housing base.

By disposition of a filter element, in particular, a paper filter, particulate and, in particular, corrosive magnetizable dust can be retained.

In a further embodiment of the invention, the filter element or the filter retaining part is provided in such a way that the air inlet openings are essentially covered over their entire surface from outside by the filter element. This facilitates sealing toward the interior and ensures easier replacement of the filter element. To ensure an effective and powerful cooling air flow, the filter element must also be easy to clean or replace, which is simpler if the filter element is positioned on the exterior of the housing base.

According to a further embodiment of the invention, the filter retaining part on the housing base is pivotably attached to the exterior. This has the advantage of captive mounting of the filter retaining part on the housing base. The filter retaining part therefore forms a sort of holding means to hold the filter element in the region of the air inlet openings on the housing base.

Because the filter retaining part can be snapped onto the housing base and engages behind an element on the housing base, the filter retaining part can be simply and quickly mounted in its intended position on the housing base of the hand-held power tool, for example, when the filter element is replaced.

Because the filter retaining part can be elastically deformed, the snap-on operation can be performed simply. The filter retaining part is simply manually pressed into its intended position. The filter retaining part then slides around the contour of the housing base, wherein it, for example, expands slightly and then snaps into a stable position. To remove or open the filter retaining part, the user can slide the filter retaining part off again in the opposite direction by effecting slight elastic expansion.

In a further embodiment of the invention, the filter retaining part can be constituted as a shell shape with openings. The shell shape then largely matches the outer contour of the housing base. In this way, the filter retaining part can be very flat and be positioned compactly on the housing base of the hand-held power tool. In this case, it is even possible for the filter retaining part to be provided in the region intended for manual holding of the hand-held power tools.

According to a further embodiment of the invention, the filter retaining part, as seen in a longitudinal direction of the housing base of the hand-held power tool and in cross-section, is approximately constituted in the shape of a circular arc with a circumferential length of preferably a little more than 180° .

Further characteristics, details, and advantages can be derived from the appended claims and from the drawings and the following description of preferred embodiments of the inventive hand-held power tool. The drawings show

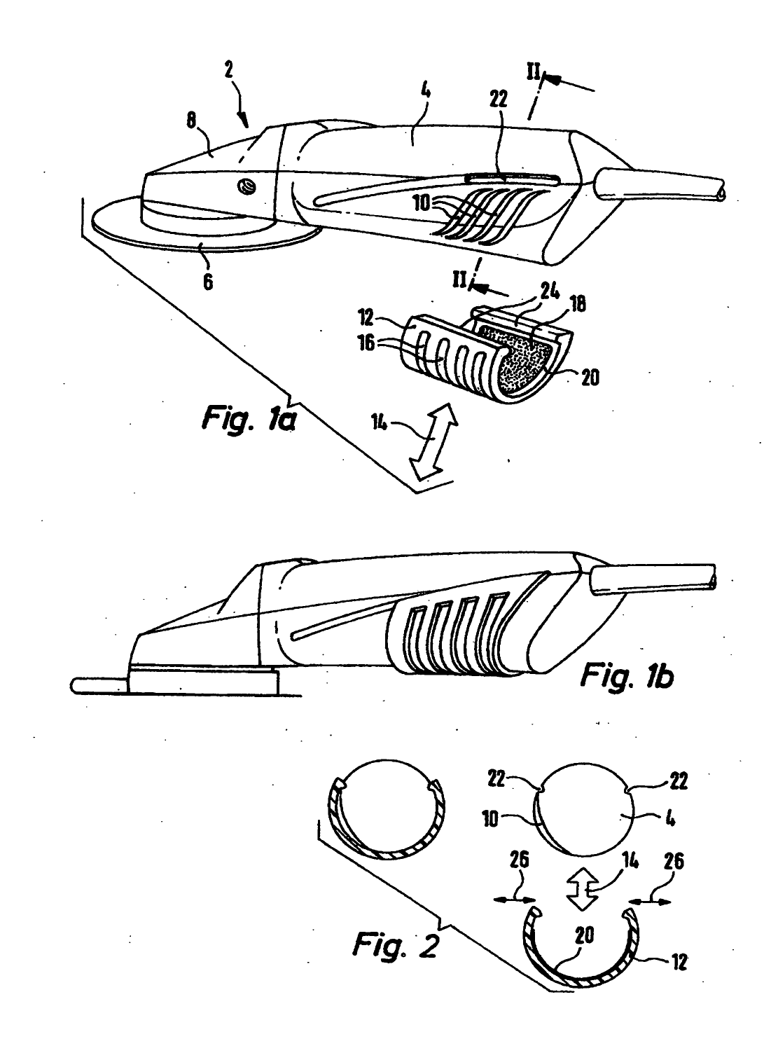

FIGS. 1 a),b) different perspective views of a first embodiment of the inventive hand-held power tool;

FIG. 2 two schematic sectional views with intersecting plane II-II of FIG. 1 to illustrate the position of a filter retaining part;

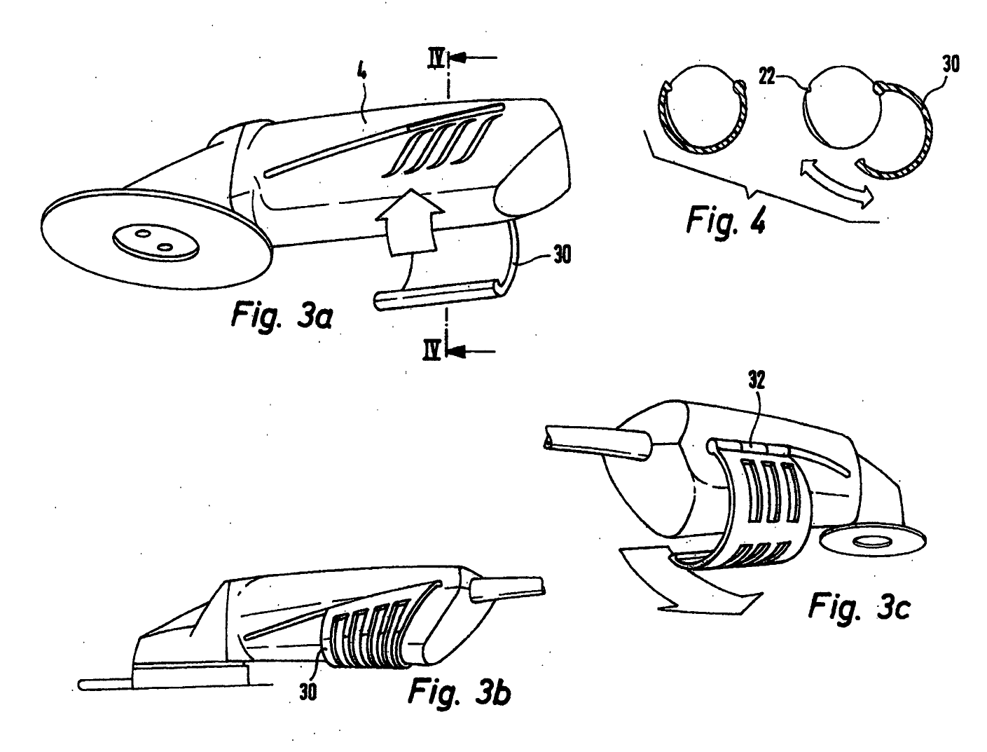

FIGS. 3a-c) different perspective views of a second embodiment of the inventive hand-held power tool and

FIG. 4 two schematic sectional views with intersecting plane IV-IV of FIG. 3 to illustrate the position of a filter retaining part.

FIGS. 1 and 2 show a hand-held power tool 2 in the form of an angle grinder with a housing base 4 accommodating the electromotive drive components and also constituting the handle part of the hand-held power tool 2. This housing base 4 comprises two plastic housing halves located one against the other in a longitudinal division plane. A typically metallic transmission housing part 8 adjoins the housing base 4 in the direction of the tool 6. In a central to rear region of the housing base 4, air inlet openings 10 are provided through which a cooling air flow is formed that cools the electromotive drive components in the interior of the housing base 4 during operation of the hand-held power tool 2. The cooling air flow suctioned into the interior of the housing base 4 through these air inlet openings 10 is blown out again at a different position, typically in the region of the transition to the transmission housing part 8.

In the region of the section of the housing base 4 comprising the air inlet openings 10, a filter retaining part 12 is snapped onto the housing base 4 from below and outside in the direction of the arrow 14. The filter retaining part 12 is constituted in the shape of a half shell and adapted to the outer contour of the housing base 4 in this region. It also has elongated openings 16. A filter element 20, in the simplest case, a sheet of a paper filter, can be positioned against the inside 18 of the filter retaining part 12 facing the housing base 4. This paper filter element then covers the air inlet openings 10 in the housing base 4 from outside and retains, in particular, corrosive magnetizable dust. FIG. 1a further shows on the outer side of the housing base 4 above the air inlet openings 10 a slot-shaped rounded recess 22, into which the filter retaining part 12 with an approximately complementarily constituted elongated engagement lug 24 can snap. This ensures that the filter retaining part 12 is stably retained on the housing base 4 while remaining removable due to its elastically compliant properties. FIG. 2 is a schematic sectional view showing how the filter retaining part 12 is snapped onto the housing base 4 in the direction of the arrow 14. Therein, the free ends of the filter retaining part 12 are slightly expanded (see double arrow 26, which shows the elastic compliance of the filter retaining part 12).

Moreover, the filter retaining part 12 can also constitute the filter element or incorporate it as an integral component. For example, it is conceivable for the filter retaining part 12 to comprise a glued-on or molded-on plastic or metal sieve or similar filter component as an integral component in the region of its openings 16.

FIGS. 3 and 4 show a further preferred embodiment of the inventive hand-held power tool 2, wherein the filter retaining part 30 is provided in such a way that it can swing around a pivot axis 32 that is essentially parallel with a longitudinal axis of the housing. The filter retaining part 30 is again constituted in the shape of a shell. The pivoting mounting is provided at one end of its circumference and the other end of the circumference is constituted by a type of snap-in lug 24 as described above for the embodiment according to FIGS. 1 and 2. The recess 22 is also constituted as in the first embodiment. Swinging open and swinging closed the filter retaining part 30 works as shown in FIGS. 3 and 4.

In this case, too, it proves advantageous if the filter retaining part 30 protrudes only a few millimeters beyond the exterior of the housing base 4 to avoid impeding handling of the hand-held power tool 2.

1-6. (canceled)

7. A battery-operated hand-held power tool or an angle grinder, the power tool accommodating electromagnetic drive components, the power tool comprising:
a housing base structured and dimensioned to contain the electromotive drive components, said housing base having air inlet openings supplying the electromotive drive components with a cooling air flow;
a filter element disposed in a region of said air inlet openings, said filter element disposed, structured and dimensioned to prevent dust from contacting the electromagnetic drive components; and
a filter retaining part attached to an exterior of said housing base to retain said filter element, said filter retaining part being slightly elastically deformed when attached to said housing base to engage behind or snap into an element on said housing base.

8. The power tool of claim 7, wherein said dust is magnetizable dust.

9. The power tool of claim 7, wherein said filter retaining part is expanded during attachment to said housing base.

10. The power tool of claim 7, wherein said air inlet openings are covered by said filter element.

11. The power tool of claim 7, wherein said housing has a slot-shaped, rounded recess into which said filter retaining part snaps or engages with approximately complementarily constituted elongated engagement lugs.

12. The power tool of claim 7, wherein said filter retaining part is attached to an exterior of said housing base in a pivotable manner.

13. The power tool of claim 7, wherein said filter retaining part is constituted in a shape of a shell having openings.

14. The power tool of claim 7, wherein, as seen in a longitudinal direction of said housing base and in cross-section, said filter retaining part is approximately constituted in a shape of a circular arc with a circumferential length of a little more than 180°.
